(19) United States
(12) Patent Application Publication
(10) Pub. No.: US 2013/0002901 A1
(43) Pub. Date: Jan. 3, 2013

(54) FINE GRAINED POWER GATING OF CAMERA IMAGE PROCESSING

(76) Inventor: Madhu S. Athreya, Saratoga, CA (US)

(21) Appl. No.: 13/175,777

(22) Filed: Jul. 1, 2011

(51) Int. Cl. H04N 5/228; H04N 9/73

(52) U.S. Cl. 348/223.1; 348/222.1; 348/E05.031; 348/E09.051

(57) ABSTRACT

Methods and apparatus relating to fine grained power gating of camera image processing are described. In an embodiment, an Image Signal Processor (ISP) includes a first partition to receive and store image sensor data in a memory during a first time period. The ISP also includes a second partition to process the stored image sensor data during a second time period that follows the first time period. The second partition is entered into a low power consumption state during the first time period. Other embodiments are also disclosed and claimed.

### FIELD

The present disclosure generally relates to the field of electronics. More particularly, some embodiments of the invention relates to fine grained power gating of camera image processing.

### BACKGROUND

As mobile computing devices become more common place, it is imperative to reduce power consumption in such devices as much as possible while maintaining usability. More particularly, since mobile computing devices generally rely on batteries with a limited life, the amount of power consumed for various operations needs to be closely guarded to increase battery life, as well as addressing thermal limits.

Furthermore, transistors optimized for performance tend to be more leaky. In order to address rapidly increasing market requirements, and accordingly higher performance needs, such transistors become a natural choice for an image signal processor. Hence, it becomes imperative to reduce leakage power through innovations other than process technology to stay competitive.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates power consumption without power gating during a an entire frame period for an incoming pixel stream.

FIGS. 2-3 illustrate block diagrams and power consumption associated with various computing devices that may be used for image signal processing, in accordance with some embodiments.

FIG. 4 illustrates a flow diagram according to an embodiment.

FIGS. 5-6 illustrate block diagrams of computing systems, according to some embodiments.

### DETAILED DESCRIPTION

In the following description, numerous specific details are set forth in order to provide a thorough understanding of various embodiments. However, some embodiments may be practiced without the specific details. In other instances, well-known methods, procedures, components, and circuits have not been described in detail so as not to obscure the particular embodiments.

Some embodiments may address power consumption of an Image Signal Processor (ISP) during still or video capture. In an embodiment, leakage power of an ISP is reduced by partitioning the ISP hardware into separate (e.g., two) power domains that may be independently powered on and off. In one embodiment, one or more frame or ring buffers may be used to process data in a burst to reduce power leakage by an image processing portion of an ISP during image capture and buffering operations. Moreover, the techniques discussed herein may be applied to any type of a ISP device, including for example mobile devices (such as a mobile phone, a laptop computer, a personal digital assistant (PDA), an ultra-portable personal computer, tablet, etc.) or non-mobile computing devices (such as a desktop computer, a server, etc.).

Furthermore, wireless or wired communication channels may be utilized for transfer of data between various components of an ISP system. The wireless communication capability may be provided by any available wireless connection, e.g., using a Wireless Wide Area Network (WWAN) such as 3^{rd} Generation (3G) WWAN (e.g., in accordance with International Telecommunication Union (ITU) family of standards under the IMT-2000), Worldwide Inter-operability for Microwave Access (“WiMAX, e.g., in accordance with Institute of Electrical and Electronics Engineers (IEEE) 802.16, revisions 2004, 2005, et seq.), Bluetooth® (e.g., in accordance with s IEEE Standard 802.15.1, 2007), Radio Frequency (RF), WiFi (e.g., in accordance with IEEE 802.11a, 802.11b, or 802.11g), etc. Also, the wired communication capability may be provided by any available wired connection, e.g., a shared or private bus (such as a Universal Serial Bus (USB)), one or more (unidirectional or bidirectional) point-to-point or parallel links, etc.

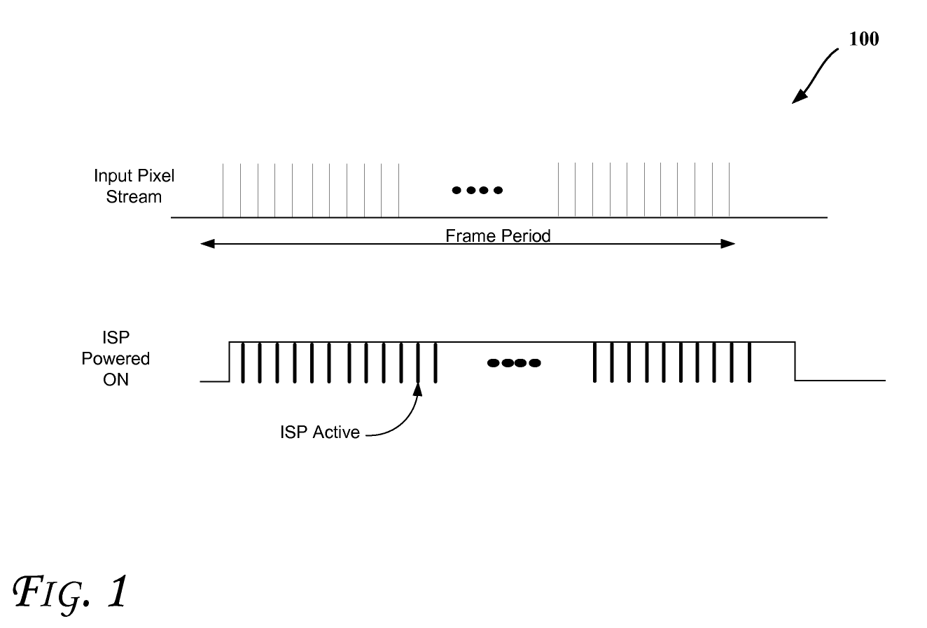

As illustrated in FIG. 1, some implementations process an incoming pixel stream from an imaging sensor as the pixels arrive and as a result no power gating during image processing is possible in such implementations. More specifically, FIG. 1 illustrates power consumption without power gating during a an entire frame period for an incoming pixel stream. Moreover, ISPs process a large amount of data from image sensors. Due to the sophisticated algorithms required, this data processing tends to be very compute intensive. Hence, dedicated ISPs, be it SIMD (Single Instruction, Multiple Data) vector processors, DSPs (Digital Signal Processors), or other processor types, are relatively large and consume a fair amount of power.

To improve battery life performance for mobile devices (such as Smartphones or tablet SoC (System on Chip), into which these ISPs are integrated), there needs to be very efficient power management. Power management may be done to manage active power, but power management may also be applied to lower the leakage power as it is becoming increasingly significant due to constantly increasing size of ISPs with each generation. To this end, some embodiments address leakage power and include novel techniques to reduce the leakage power consumption.

Generally, camera image sensors do not include frame buffers, and without being able to buffer the pixels after exposure, sensors send the pixel data out as and when the pixels are exposed. Furthermore, the excitation from the light sources is continuous and the integration happens over the entire frame time. As a consequence, these sensors transmit pixels over the entire frame period. This arrival rate at the ISPs has an impact on leakage power if the processing capacity exceeds the input pixel rate. For instance, if the ISP is designed to process a full frame of M megapixels, then for a decimated frame, say, by a factor of two in each X, Y, the ISP is required only 25% of the time. But in practice, since the pixel arrival rate is spread throughout the frame, the ISP has no opportunity to be powered off as shown in FIG. 1. The situation illustrated in FIG. 1 may be typically the case during viewfinder mode, which utilizes an ISP only a fraction of the total frame time to process. A viewfinder mode generally refers to a mode where a user is composing the picture and before actually capturing image or video data that is to be processed and stored, for example. In some cases, the utilization may be less than 10% of the ISP time. With increasing megapixels and commensurate ISP performance, and with viewfinder frame sizes remaining static due to, e.g., phone display size, this utilization will likely reduce further in future. Which means the ISP is powered ON for 90% more time than necessary, wasting leakage power while it could be powered OFF. Another compelling reason to optimize around viewfinder is because it is in this mode that the user spends more than 99% of the time composing the picture before actually capturing the picture. Hence, it is the viewfinder average power which dominates total average power of a camera.

In an embodiment, a similar optimization is also applicable during video mode. More particularly, most ISPs are designed to process multi-megapixel full image frames during still capture. These ISPs will require a fraction of the time to process a video frame, even for 1080p video as the frame size is only 2 Mega pixels. During video processing, with conventional implementation, ISPs remain ON burning leakage power, e.g., for more than 70% of the time, in excess of the duration ISPs are actually required for processing the video frame.

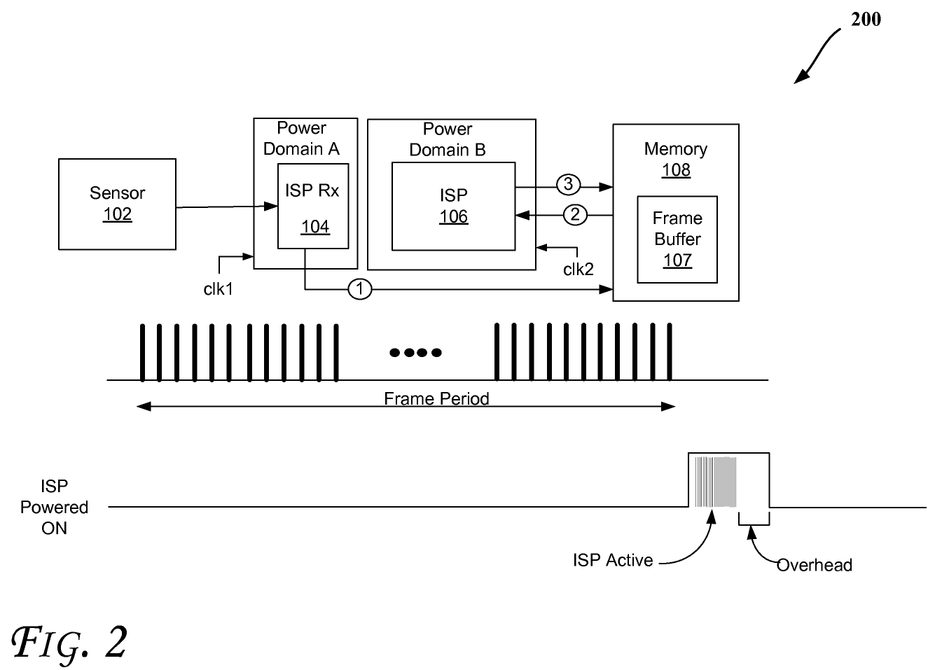

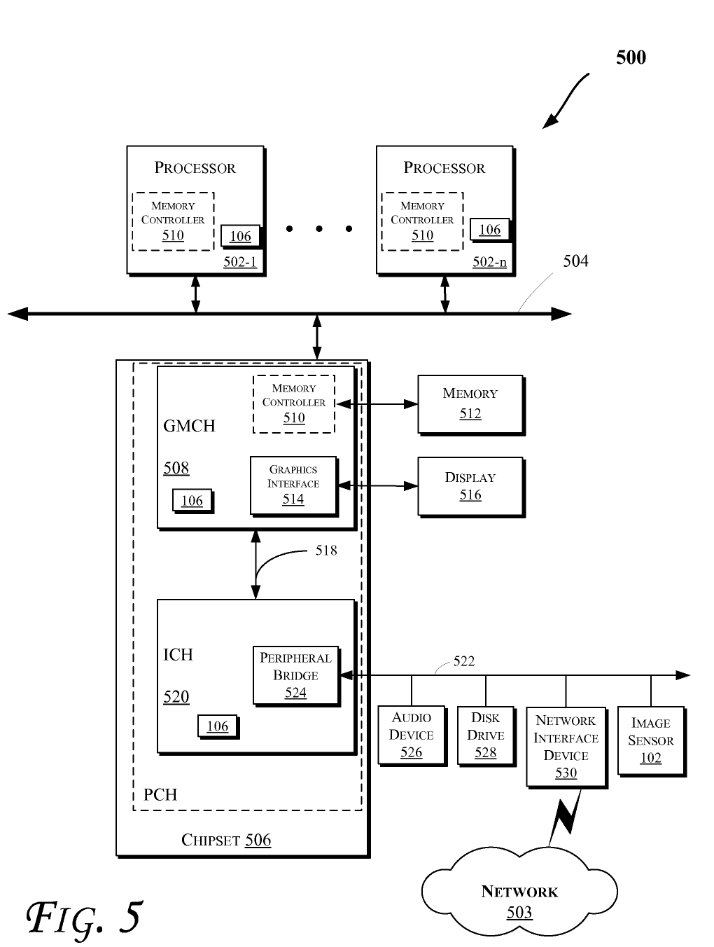

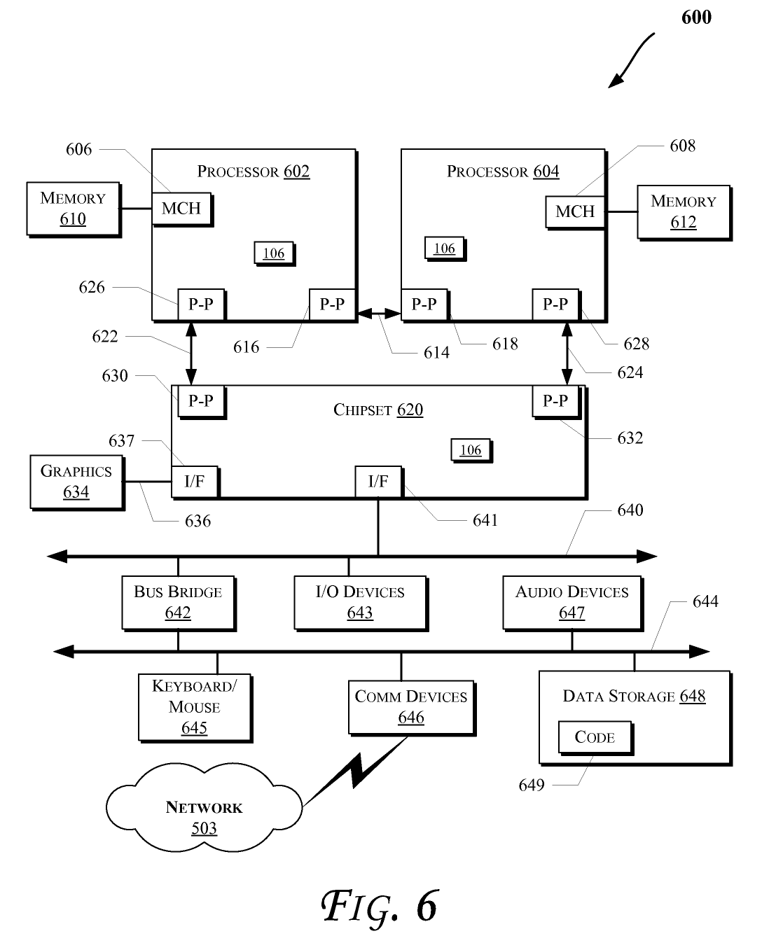

FIG. 2 illustrates an image processing system 200 according to an embodiment. In an embodiment, the time constraints imposed by a sensor 102 (such as a CMOS (Complementary Metal-Oxide Semiconductor) sensor) is removed. Instead of directly processing the pixels as they arrive from a sensor 102 (such as a CMOS (Complementary Metal-Oxide Semiconductor) sensor) at an ISP 106, these pixels are acquired into a frame buffer 107 in a memory 108 as shown in operation 1 in FIG. 2. In an embodiment, the ISP 106 may include a variety of processor types (such as a processor with a plurality of processor cores and/or the types of processors discussed with reference to processors 502 of FIG. 5). Furthermore, any type of memory may be used for the memory 108 such as those discussed with reference to memory 512 of FIG. 5 and/or memories 610/612 of FIG. 6. Once the full frame is acquired, the acquired frame is sent to the ISP 106 (e.g., in a burst transfer) as shown in operation 2. The ISP 106 may now process the received data at once, and the result is written back to memory 108 as indicated by operation 3. So in effect the ISP processing, which was previously spread out over the entire frame in conventional implementation, now completes processing all in one short burst. For viewfinder this burst could be less than 10% of frame time and for video this could be less than 30% of frame time.

In one embodiment, two separate power domains (also referred to herein as partitions) may be used for an ISP, one (power domain A) for the ISP receiver 104 circuitry and the other (power domain B) for the ISP processor 106 circuitry. Each domain may be supplied by separate power rails, isolation circuits and/or clock signals (e.g., clk1 and clk2) to allow for power gating of each domain independently. In one embodiment, clocks clk1 and clk2 may be derived from a same clock signal (e.g., by using a clock divider). As discussed herein, power gating generally refers to controlling the level of operations in a given domain (e.g., by controlling the frequency of a clock supplied to the domain). In an embodiment, to power off a domain, its respective clock may be turned off. Alternatively, the clock may be slowed down instead of totally shutting it off (e.g., to reduce the overhead/delay associated with bringing the shut off circuits online and operational or to otherwise reduce power consumption). The ISP receiver 104 area in comparison to the ISP area may be insignificant in an embodiment. So, when the pixels are being acquired from the sensor 102 into the frame buffer 107 in memory 108, only the ISP receiver 104 circuitry is ON. In other words, only the ISP receiver 104 circuitry needs to be ON for the entire frame time. The processor portion of the ISP 106 on the other hand remains OFF when the pixels are being acquired and is turned ON for the duration when it has to process the already stored frame.

Accordingly, in one embodiment, the ISP may include two partitions. The ISP processor partition may be put into a low power consumption state during a first time period when the ISP receiver partition is receiving (and storing the sensor data in the memory). In various embodiments, the low power consumption state may include a partial power consumption state or an complete power off state. During a second time period (e.g., after the captured image sensor data is stored in memory), the ISP processor partition may process the stored image data. Also, the ISP receive partition may receive and store additional image sensor data in the memory during a third time period that overlaps with or follows the second time period. Further, since ISP area may be a significant contributor to the leakage power, power leakage is efficiently managed by the aforementioned technique. For instance during viewfinder, the ISP leakage may be reduced close to 90% and for video leakage may be lowered by close to 70%. In some embodiments, a finer power domain partitioning of ISP processors may be provided to further reduce power consumption, e.g., power gating of even the ISP processor portion components. By having multiple ISP processor power domains, there is further opportunity for reducing power leakage when the ISP is under-utilized.

As the implementations of camera systems vary, some embodiments of the invention further address two alternate implementations. In the first alternate embodiment, the sensor 102 sends the full frame even during viewfinder of video. This is done as sometimes the sensor binning or scaling support is inadequate or of low quality. In this alternate embodiment, the ISP Rx 104 includes a scaler engine/block/logic. This scaler logic may downscale the incoming full frame to the target frame resolution, be it viewfinder frame size or video frame size. By doing so, only the required data is written into the frame buffer 107 in memory 108, e.g., to reduce storage requirements, memory/interconnect bandwidth usage, power consumption of memory/interconnect, etc. The next embodiment might choose to not only acquire the full frame from the sensor 102 but also to store the full RAW Bayer frame in frame buffer 107. Generally, Bayer format refers to a color space associated with arrangement of an array of color filters of Red, Green, and Blue (RGB) on a grid of photo sensors used in some digital image sensors. In some embodiments, the ISP 106 may convert the image sensor data from an RGB color space to a YUV (Luminance-Bandwidth-Chrominance) color space, e.g., prior to storing the data in the memory 108 or otherwise for chroma/luma modifications/corrections. For such embodiments, the scaler logic may be present in the ISP Rx 104 partition (power domain A) such that when the frame is being processed it may first be downscaled and processed according to the requirement of the target resolution before storing the processed data in the memory 108.

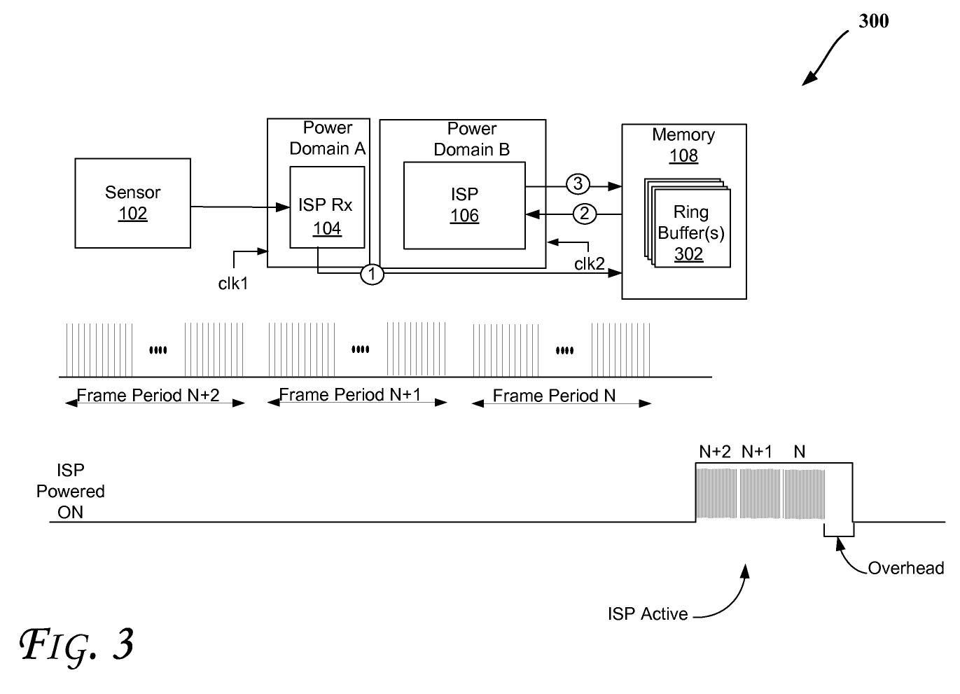

As shown in FIG. 2, powering the ISP ON and OFF may incur additional overhead. Even though the ISP processing may be completed efficiently in a bursty manner, the ISP might remain ON for a period before and/or after ISP processing. This might be due to overheads such as enabling/disabling power gating circuitry. An embodiment addresses this for further savings in leakage power. In order to achieve this, a ring buffer may be used which stores more than one frame. This is shown in FIG. 3. In this case, the ISP processing is commenced only when n number of frames are accumulated in the ring buffer 302. The ISP processes all the n frame at once. Once this processing is completed the ISP is powered OFF. By so doing, for each frame the overhead may be reduced by a factor of n.

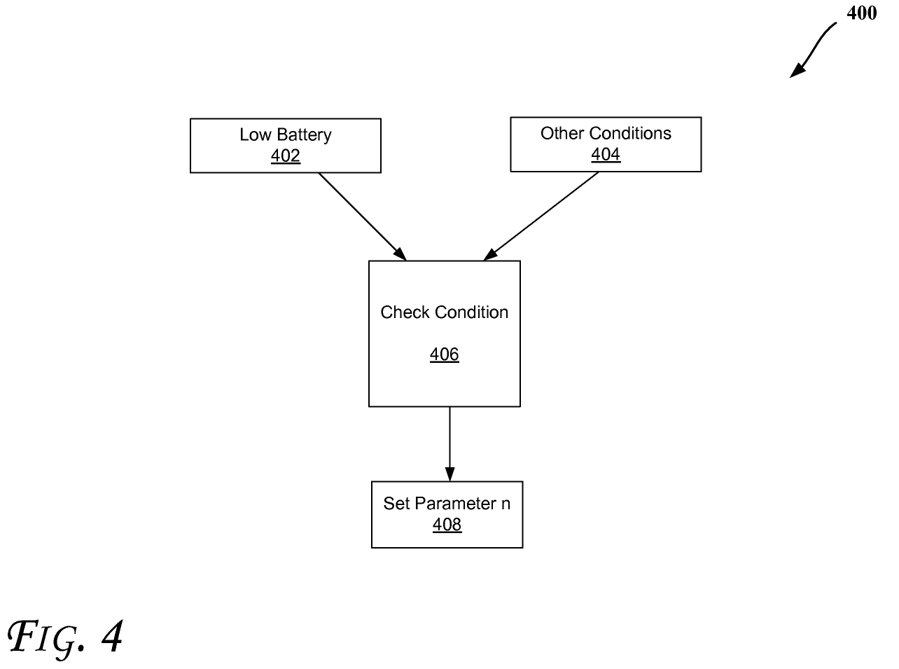

Delaying the processing of frames results in a lag from the time the user captures an image/video to the time the user actually sees the captured image/video on a display. This delay may be acceptable up to two to three frames in typical conditions to maintain a good user experience. FIG. 4 illustrates a decision processing method 400, according to an embodiment. In conditions such as low battery conditions 402, the user may be willing to accept two or three additional frame delays. In accordance with one embodiment, the factor n will be a function of these considerations and an embodiment upon detection of various conditions 402/404, checks the specific condition at operation 406, and adjusts parameter n 408 accordingly. For example, parameter n may even be 1, in which case the ring buffers 302 would amount to a single frame buffer. Various considerations may be taken into account when setting the parameter n at operation 408. For example, a table indicating what n is to be used for each type of condition may be used. This information may be configured based on the type of device, ISP capability/speed, memory speed/bandwidth of memory 108, interconnect speed/bandwidth, target level for power consumption (e.g., depending on a target power consumption state setting), battery performance, etc.

The ISP architecture and techniques described above may be employed in various types of computer systems (such as the systems discussed with reference to FIGS. 5 and/or 6). For example, FIG. 5 illustrates a block diagram of a computing system 500 in accordance with an embodiment of the invention. The computing system 500 may include one or more central processing unit(s) (CPUs) 502 or processors that communicate via an interconnection network (or bus) 504. The processors 502 may include a general purpose processor, a network processor (that processes data communicated over a computer network 503), or other types of a processor (including a reduced instruction set computer (RISC) processor or a complex instruction set computer (CISC)). Moreover, the processors 502 may have a single or multiple core design. The processors 502 with a multiple core design may integrate different types of processor cores on the same integrated circuit (IC) die. Also, the processors 502 with a multiple core design may be implemented as symmetrical or asymmetrical multiprocessors.

Furthermore, the operations discussed with reference to FIGS. 1-4 may be performed by one or more components of the system 500. For example, the ISP 106 discussed with reference to FIGS. 1-4 may be present in one or more components of the system 500 (such as shown in FIG. 5 or other components not shown). Also, the system 500 may include the image sensor 102 or a digital camera such discussed with reference to FIG. 1-4.

A chipset 506 may also communicate with the interconnection network 504. The chipset 506 may include a graphics and memory control hub (GMCH) 508. The GMCH 508 may include a memory controller 510 that communicates with a memory 512. The memory 512 may store data, including sequences of instructions, that may be executed by the CPU 502, or any other device included in the computing system 500. In one embodiment of the invention, the memory 512 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 504, such as multiple CPUs and/or multiple system memories.

The GMCH 508 may also include a graphics interface 514 that communicates with a display device 516. In one embodiment of the invention, the graphics interface 514 may communicate with the display device 516 via an accelerated graphics port (AGP) or PCIe. In an embodiment of the invention, the display 516 (such as a flat panel display) may communicate with the graphics interface 514 through, for example, a signal converter that translates a digital representation of an image stored in a storage device such as video memory or system memory into display signals that are interpreted and displayed by the display 516. The display signals produced by the display device may pass through various control devices before being interpreted by and subsequently displayed on the display 516.

A hub interface 518 may allow the GMCH 508 and an input/output control hub (ICH) 520 to communicate. The ICH 520 may provide an interface to I/O device(s) that communicate with the computing system 500. The ICH 520 may communicate with a bus 522 through a peripheral bridge (or controller) 524, such as a peripheral component interconnect (PCI) bridge, a universal serial bus (USB) controller, or other types of peripheral bridges or controllers. The bridge 524 may provide a data path between the CPU 502 and peripheral devices. Other types of topologies may be utilized. Also, multiple buses may communicate with the ICH 520, e.g., through multiple bridges or controllers. Moreover, other peripherals in communication with the ICH 520 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., Digital Video Interface (DVI)), High Definition Multimedia Interface (HDMI), or other devices.

The bus 522 may communicate with an audio device 526, one or more disk drive(s) 528, and a network interface device 530 (which is in communication with the computer network 503). Other devices may communicate via the bus 522. Also, various components (such as the network adapter 530) may be coupled to the GMCH 508 in some embodiments of the invention. In addition, the processor 502 and the GMCH 508 may be combined to form a single chip. In an embodiment, the memory controller 510 may be provided in one or more of the CPUs 502. Further, in an embodiment, GMCH 508 and ICH 520 may be combined into a Peripheral Control Hub (PCH).

Furthermore, the computing system 500 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 528), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

FIG. 6 illustrates a computing system 600 that is arranged in a point-to-point (PtP) configuration, according to an embodiment of the invention. In particular, FIG. 6 shows a system where processors, memory, and input/output devices are interconnected by a number of point-to-point interfaces.

Furthermore, the operations discussed with reference to FIGS. 1-5 may be performed by one or more components of the system 600. For example, the ISP 106 discussed with reference to FIGS. 1-5 may be present in one or more components of the system 600 (such as shown in FIG. 6 or other components not shown). Also, the system 600 may include the image sensor 102 or a digital camera (not shown) such discussed with reference to FIG. 1-5. The image sensor 102 may be coupled one or more components of system 600 such as a bus (e.g., bus 640 and/or 644) of system 600, the chipset 620, and/or processor(s) 602 or 604.

As illustrated in FIG. 6, the system 600 may include several processors, of which only two, processors 602 and 604 are shown for clarity. The processors 602 and 604 may each include a local memory controller hub (MCH) 606 and 608 to enable communication with memories 610 and 612. The memories 610 and/or 612 may store various data such as those discussed with reference to the memory 512 of FIG. 5.

In an embodiment, the processors 602 and 604 may be one of the processors 502 discussed with reference to FIG. 5. The processors 602 and 604 may exchange data via a point-to-point (PtP) interface 614 using PtP interface circuits 616 and 618, respectively. Also, the processors 602 and 604 may each exchange data with a chipset 620 via individual PtP interfaces 622 and 624 using point-to-point interface circuits 626, 628, 630, and 632. The chipset 620 may further exchange data with a graphics circuit 634 via a graphics interface 636, e.g., using a PtP interface circuit 637.

At least one embodiment of the invention may be provided within the processors 602 and 604. Other embodiments of the invention, however, may exist in other circuits, logic units, or devices within the system 600 of FIG. 6. Furthermore, other embodiments of the invention may be distributed throughout several circuits, logic units, or devices illustrated in FIG. 6.

The chipset 620 may communicate with a bus 640 using a PtP interface circuit 641. The bus 640 may communicate with one or more devices, such as a bus bridge 642 and/or I/O devices 643. Via a bus 644, the bus bridge 642 may communicate with other devices such as a keyboard/mouse 645, communication devices 646 (such as modems, network interface devices, or other communication devices that may communicate with the computer network 503), audio I/O device 647, and/or a data storage device 648. The data storage device 648 may store code 649 that may be executed by the processors 602 and/or 604.

In various embodiments of the invention, the operations discussed herein, e.g., with reference to FIGS. 1-6, may be implemented as hardware (e.g., circuitry), software, firmware, microcode, or combinations thereof, which may be provided as a computer program product, e.g., including a (e.g., non-transitory) machine-readable or (e.g., non-transitory) computer-readable medium having stored thereon instructions (or software procedures) used to program a computer to perform a process discussed herein. Also, the term “logic” may include, by way of example, software, hardware, or combinations of software and hardware. The machine-readable medium may include a storage device such as those discussed herein. Additionally, such computer-readable media may be downloaded as a computer program product, wherein the program may be transferred from a remote computer (e.g., a server) to a requesting computer (e.g., a client) via a communication link (e.g., a bus, a modem, or a network connection).

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1. An image signal processor comprising:
a first partition to receive and store image sensor data in a memory during a first time period;
a second partition to process the stored image sensor data during a second time period that follows the first time period,
wherein the second partition is to be in a low power consumption state during the first time period.

2. The image signal processor of claim 1, wherein the low power consumption state is to comprise a partial power consumption state or a complete power off state.

3. The image signal processor of claim 1, wherein the memory is to comprise a frame buffer to store the image sensor data.

4. The image signal processor of claim 1, wherein the first partition is to receive and store additional image sensor data in the memory during a third time period that overlaps or follows the second time period.

5. The image signal processor of claim 1, wherein the memory is to comprise one or more ring buffers to store one or more frames of image sensor data.

6. The image signal processor of claim 5, wherein the second partition is to process the stored image sensor data after a number of frames are stored in the one or more ring buffers.

7. The image signal processor of claim 6, wherein the number of frames is to be defined based on one or more of: a type of device that comprises the image signal processor, capability or speed of the image signal processor, speed or bandwidth of memory, speed or bandwidth of an interconnect that couples the image signal processor and the memory, and a target level for power consumption.

8. The image signal processor of claim 6, wherein the number of frames is to be defined in response to occurrence of a condition.

9. The image signal processor of claim 1, wherein the first partition is to comprise a scaler logic to downscale the image sensor data prior to storage of the image sensor data in the memory.

10. The image signal processor of claim 1, wherein the image sensor data is generated by an image sensor in Bayer format.

11. The image signal processor of claim 1, wherein the image sensor data is to be converted from a Red, Green, and Blue (RGB) color space to a Luminance-Bandwidth-Chrominance (YUV) color space.

12. The image signal processor of claim 1, further comprising a plurality of processor cores.

13. A method comprising:
receiving, at a first partition, and storing image sensor data in a memory during a first time period; and
processing, at a second partition, the stored image sensor data during a second time period that follows the first time period,
wherein the second partition is to be in a low power consumption state during the first time period.

14. The method of claim 13, wherein the low power consumption state is to comprise a partial power consumption state or a complete power off state.

15. The method of claim 13, wherein storing the image sensor data in the memory comprises storing the image sensor data in a frame buffer of the memory.

16. The method of claim 13, further comprising receiving and storing additional image sensor data in the memory during a third time period that overlaps or follows the second time period.

17. The method of claim 13, wherein storing the image sensor data in the memory comprises storing one or more frames of the image sensor data in one or more ring buffers of the memory.

18. The method of claim 17, wherein processing the stored image sensor data is performed after a number of frames are stored in the one or more ring buffers.

19. The method of claim 18, wherein the number of frames is defined based on one or more of: a type of device that comprises the image signal processor, capability or speed of the image signal processor, speed or bandwidth of memory, speed or bandwidth of an interconnect that couples the image signal processor and the memory, and a target level for power consumption.

20. The method of claim 18, wherein the number of frames is defined to occurrence of a condition.

21. The method of claim 13, further comprising downscaling the image sensor data, at the first partition, prior to storage of the image sensor data in the memory.

22. The method of claim 13, further comprising generating the image sensor data, at an image sensor, in Bayer format.

23. The method of claim 13, further comprising converting the image sensor data from an RGB color space to a YUV color space.

24. A system comprising:
a memory to store image sensor data to be captured by an image sensor;
a processor coupled to the memory, the processor comprising:
a first partition to receive and store the image sensor data in the memory during a first time period;
a second partition to process the stored image sensor data during a second time period that follows the first time period,
wherein the second partition is to be in a low power consumption state during the first time period.

25. The system of claim 24, wherein the low power consumption state is to comprise a partial power consumption state or a complete power off state.

26. The system of claim 24, wherein the memory is to comprise a frame buffer to store the image sensor data.

27. The system of claim 24, wherein the first partition is to receive and store additional image sensor data in the memory during a third time period that overlaps or follows the second time period.

28. The system of claim 24, wherein the memory is to comprise one or more ring buffers to store one or more frames of image sensor data.

29. The system of claim 28, wherein the second partition is to process the stored image sensor data after a number of frames are stored in the one or more ring buffers.

30. The system of claim 24, wherein the first partition is to comprise a scaler logic to downscale the image sensor data prior to storage of the image sensor data in the memory.
